(19) United States
(12) Patent Application Publication
(10) Pub. No.: US 2023/0306184 A1
(43) Pub. Date: Sep. 28, 2023

(54) DISPLAY APPARATUS, DISPLAY METHOD, AND PROGRAM

(71) Applicant: Takuroh YOSHIDA, Kanagawa (JP)

(72) Inventor: Takuroh YOSHIDA, Kanagawa (JP)

(21) Appl. No.: 18/024,774

(22) PCT Filed: Sep. 29, 2021
(86) PCT No.: PCT/JP2021/036007

§ 371 Date: Mar. 6, 2023

(30) Foreign Application Priority Data
Sep. 30, 2020 (JP) 2020-166450

(51) Int. Cl. G06F 40/106; G06F 40/109; G06V 30/32; G06F 40/171

(52) U.S. Cl. CPC G06F 40/106; G06F 40/109; G06V 30/32; G06F 40/171

(57) ABSTRACT

A display apparatus includes a processor; and a memory that includes instructions, which when executed, cause the processor to: receive handwritten data that is input; convert the handwritten data into text data; and, in response to first text data that is being displayed and the handwritten data that is received satisfying a predetermined condition, control, based on a display position of the first text data, a display position of second text data obtained from converting the handwritten data.

### TECHNICAL FIELD

The present invention relates to a display apparatus, a display method, and a program.

### BACKGROUND ART

Display apparatuses which use handwritten recognition techniques to convert handwritten data into text data and display the text data on displays are known. Display apparatuses with relatively large touch panels, as electronic blackboards and the like, are located in conference rooms and the like and are used by multiple users.

In the related art, there is a technology in which a system converts handwritten data on a ruler line into text data as a result of a user handwriting on the ruler line. On the other hand, a technique that eliminates the need for ruler lines has been devised (see, for example, PTL 1). PTL 1 discloses a system capable of converting handwritten data into text data even if a user handwrites data at any location.

### SUMMARY OF INVENTION

### Technical Problem

However, there is a problem in that a display apparatus in the related art cannot control a display position of another set of text data based on a position of one set of text data. For example, if a user inputs handwritten data with an elapse of a time after inputting text data or if a user inputs handwritten data at a place away from a place of having input text data, text data converted from the handwritten data is displayed at a handwritten location. Therefore, even if the user handwrites semantically linked contents with respect to the text data already displayed, the display apparatus does not display the handwritten data to form a single sentence together with the already displayed text data. In addition, even if a user wants to display multiple sets of text data to have the same line head positions, it is not possible to display the multiple sets of text data having the same line head positions.

It is an object of the present disclosure to, in view of the above-described situation, provide a display apparatus capable of controlling a display position of another set of text data based on a position of one set of text data.

### Solution to Problem

In view of the above-described situation, according to one aspect of the present disclosure, a display apparatus includes a reception unit configured to receive handwritten data input through an input unit; a converting unit configured to convert the handwritten data into text data; and a display position control unit configured to, in response to first text data that is being displayed and the handwritten data received by the reception unit satisfying a predetermined condition, control, based on a display position of the first text data, a display position of second text data obtained from converting the handwritten data by the converting unit.

### Advantageous Effects of Invention

A display apparatus that controls a display position of another set of text data based on a position of one set of text data can thus be provided.

Other objects, features, and advantages of the present disclosure will become more apparent from the following detailed description when read in conjunction with the accompanying drawings.

### BRIEF DESCRIPTION OF DRAWINGS

FIG. 1 illustrates a display apparatus that does not align text data converted from handwritten data.

FIG. 2 is a diagram illustrating examples where two sets of text data are aligned.

FIG. 3 depicts an example of a perspective view of a pen.

FIG. 4 depicts an example of a diagram depicting an overall configuration of a display apparatus.

FIG. 5 depicts an example of a hardware configuration diagram of the display apparatus.

FIG. 6 depicts an example of a functional block diagram describing functions of the display apparatus.

FIG. 7 is a diagram depicting an example of an operation guide and selectable candidates displayed in the operation guide.

FIG. 8 is an example of a diagram explaining predetermined conditions.

FIG. 9 depicts an example of a diagram illustrating an alignment in a case of overlap when viewed in a vertical direction.

FIG. 10 depicts a diagram illustrating a method of alignment when text data is of vertical writing and handwritten data overlaps with the text data when viewed in a vertical direction.

FIG. 11 is a diagram illustrating a method of alignment when text data is of vertical writing and handwritten data overlaps with the text data when viewed in a horizontal direction.

FIG. 12 is a diagram illustrating a method of alignment when first text data is a character or a mark to be added at a line head for an item-by-item writing style.

FIG. 13 depicts an example of a diagram illustrating a method of alignment in a case of English.

FIG. 14 depicts an example of a flowchart illustrating a process of aligning second text data with first text data by the display apparatus.

FIG. 15 is an example of a flowchart illustrating a process of aligning second text data with first text data in a case of an on-a-per-word-basis space inserting type language.

FIG. 16A is a diagram illustrating a method of selecting text data by circling.

FIG. 16B is a diagram illustrating a method of selecting text data by using a horizontal line;

FIG. 17 depicts an example of a flowchart illustrating a process of aligning a selected character string separated from text data by the display apparatus.

FIG. 18 is a diagram depicting another configuration example of the display apparatus.

FIG. 19 is a diagram depicting another configuration example of the display apparatus.

FIG. 20 is a diagram depicting another configuration example of the display apparatus.

FIG. 21 is a diagram depicting another configuration example of the display apparatus.

### DESCRIPTION OF EMBODIMENTS

Hereinafter, a display apparatus, as an example of a present embodiment of the present invention, and a display method performed by the display apparatus will be described with reference to the drawings.

### First Embodiment

<Description of Comparative Example of Modifying a Display of Character Strings>

First, a comparative example will be described for a reference for a help for describing the present embodiment. It should be noted that the comparative example is not necessarily related art or a publicly known art.

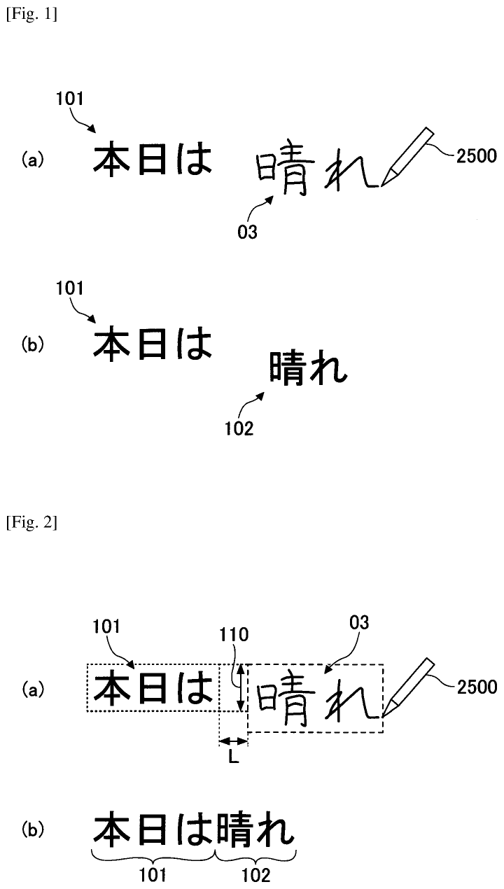

FIG. 1 is a diagram for illustrating a display apparatus that does not display text data converted from handwritten data based on a position of text data already displayed. It is simply referred to as not “aligned” that another set of text data is not displayed based on a position of one set of text data.

As depicted in FIG. 1 (a), first text data 101 is displayed as
“ [symbol] ”

(meaning “it is”). In this state, a user then inputs handwritten data 03
“ [symbol] ”

(meaning “fine”). As will be described later, the display apparatus displays one or more character string candidates (candidates of conversion results) of text data for the handwritten data 03 to be converted into the text data, and the user selects a candidate
“ [symbol] ”.

FIG. 1 (b) depicts text data displayed by the display apparatus after the user selects
“ [symbol] ”.

As depicted in FIG. 1 (b), second text data 102 input by the user at a distance greater than a certain distance with respect to the first text data 101 or after an elapse of a certain time is displayed just at the user's handwritten location.

However, these two character strings
“ [symbol] ”

and
“ [symbol] ”

are semantically linked, and the user may want to display
“ [symbol] ”

and
“ [symbol] ”

in alignment, side by side. In this case, the user needs to handwrite
“ [symbol] ”

in such a way that
“ [symbol] ”

is not spaced apart and the top and bottom positions are aligned. However, it is not easy to handwrite so as to prevent
“ [symbol] ”

from being shifted from
“ [symbol] ”.

If the user handwrites
“ [symbol] ”
   before an elapse of a certain period of time or less after
“ [symbol] ”
   is displayed, the display apparatus can align
“ [symbol] ”
   with
“ [symbol] ”,
   provided that
“ [symbol] ”
   and
“ [symbol] ”
   are within a certain distance. This function is used to automatically correct user's handwritten text to have a proper appearance. However, when a certain period of time elapsed after
“ [symbol] ”
   is displayed, or when a distance between
“ [symbol] ”
   and
“ [symbol] ”
   is greater than a certain distance, it is difficult to display
“ [symbol] ”
   and
“ [symbol] ”
   in alignment, side by side, as described above.

<How to align text data according to present embodiment>

Therefore, a display apparatus according to the present embodiment aligns
“ [symbol] ”
   with
“ [symbol] ”
   on the condition that predetermined conditions are fulfilled even when a certain time elapses after
“ [symbol] ”
   is displayed, or even when a distance between
“ [symbol] ”
   and
“ [symbol] ”
   is a certain distance or more.

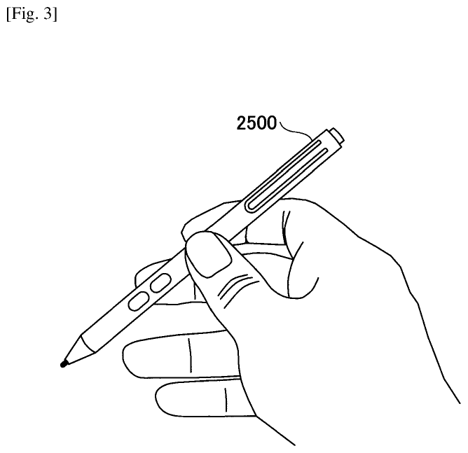

FIG. 2 is a diagram illustrating an example of aligning two sets of text data. The predetermined conditions are as follows, for example:
(i) A distance between the mutually nearest points of first text data and handwritten data is smaller than (or smaller than or equal to) a threshold.
(ii) First text data and handwritten data overlap when viewed in a horizontal direction or a vertical direction

In FIG. 2 (a), a distance L between the mutually nearest points of the first text data 101 and the handwritten data 03 is smaller than a threshold (note: the threshold is greater than the above-described certain distance). The first text data 101 and the handwritten data 03 have a horizontally overlap length 110 (i.e., a length for which the first text data 101 and the handwritten data 03 overlap when viewed in a horizontal direction). Therefore, the condition (ii) is satisfied, and thus, as depicted in FIG. 2 (b), the display apparatus aligns the second text data 102, which is,
“ [symbol] ”,

converted from the handwritten data 03, horizontally with respect to the first text data 101, which is
“ [symbol] ”.

Thus, the display apparatus of the present embodiment can control a display position of another set of text data based on a position of one set of text data when the predetermined conditions are satisfied. That is, two sets of text data can be aligned. For example, two semantically linked sets of text data are displayed in alignment, making the corresponding characters easier for a user to read.

### Terminology

An input unit may be any device or thing that allows handwriting by inputting coordinates from a touch panel. Examples include a pen, a human finger or hand, and a rod-like member. A stroke is a series of operations including a user pressing the input unit on the display (i.e., the touch panel), moving the input unit continuously, and then, separating the input unit from the display. Stroke data is information displayed on the display based on a trajectory of coordinates input with the use of the input unit. Stroke data may be interpolated as appropriate. Data handwritten through a stroke is referred to as stroke data. Handwritten data includes one or more sets of stroke data. What is displayed on the display based on stroke data is referred to as an object.

Text data is a character or characters processed by a computer. Actually, text data is a character code. A character may be a numerical digit, an alphabetical letter, a symbol, or the like.

First text data is text data displayed before handwritten data is handwritten, the handwritten data being converted into second text data. In the example of FIG. 2, first text data is
“ [symbol] ”.

Second text data is text data converted from handwritten data that is handwritten in a state where the first text has been displayed. In the example of FIG. 2, the second text data is
“ [symbol] ”.

First text data may be text data converted from handwritten data input by a user or text data present on a page read by the display apparatus from a file or the like. First text data is not limited to a character, and may be a symbol or the like such as a numerical digit, an alphabetical letter, “⋅”,
“ [symbol] ”,

“!”, “#”, “$”, “%”, “&”, “,”, “(”, “)”, “ [symbol] ”, or the like. In addition, a stamp of, such as,
“ [symbol] ”

(meaning “completed”) or
“ [symbol] ”
   (meaning “secret”) may be used as first text data. A language of first text data is not limited to Japanese

Controlling a display position of another set of text data based on a position of one set of text data means determining a position of another set of text data based on a position of one set of text data. Accordingly, another set of text data may be moved to a position different from a position where the another set of text data has been originally handwritten. In the present embodiment, for simplicity of description, a term “alignment” or “aligning” is used for “controlling a position of another set of text data based on a position of one set of text data”.

<Example of Pen's Appearance>

FIG. 3 depicts an example of a perspective view of a pen 2500. FIG. 3 depicts an example of a multifunctional pen 2500. The pen 2500, which has a built-in power source and can send instructions to the display apparatus 2, is referred to as an active pen (note: a pen without a built-in power source is referred to as a passive pen). The pen 2500 of FIG. 3 has one physical switch at a tip of the pen, one physical switch at a butt of the pen, and two physical switches at sides of the pen. The tip switch of the pen is for writing, the butt switch of the pen is for erasing, and the side switches of the pen are for assigning user functions. The pen 2500 of the present embodiment has a non-volatile memory and stores a pen ID that does not overlap with any IDs of other pens.

An operation procedure of a user for the display apparatus 2 can be reduced by using such a pen with switches. A pen with switches mainly refer to as an active pen. However, even a passive pen with no built-in power source of an electromagnetic induction type can generate power only through a LC circuit, and thus, the pen 2500 may be also a passive pen of an electromagnetic induction type as well as an active pen. In addition, pens with switches also of optical, infrared, and capacitance types, respectively, in addition to an electromagnetic induction type, are active pens.

A hardware configuration of the pen 2500 is the same as a hardware configuration of a common control system including a communication function and a microcomputer. A coordinate input system of the pen 2500 may be an electromagnetic induction system, an active electrostatic coupling system, or the like. The pen 2500 may have functions such as a pressure detection function, a tilt detection function, and a hover function (indicating a cursor on a display before a pen actually touches the display).

<Overall Configuration of Apparatus>

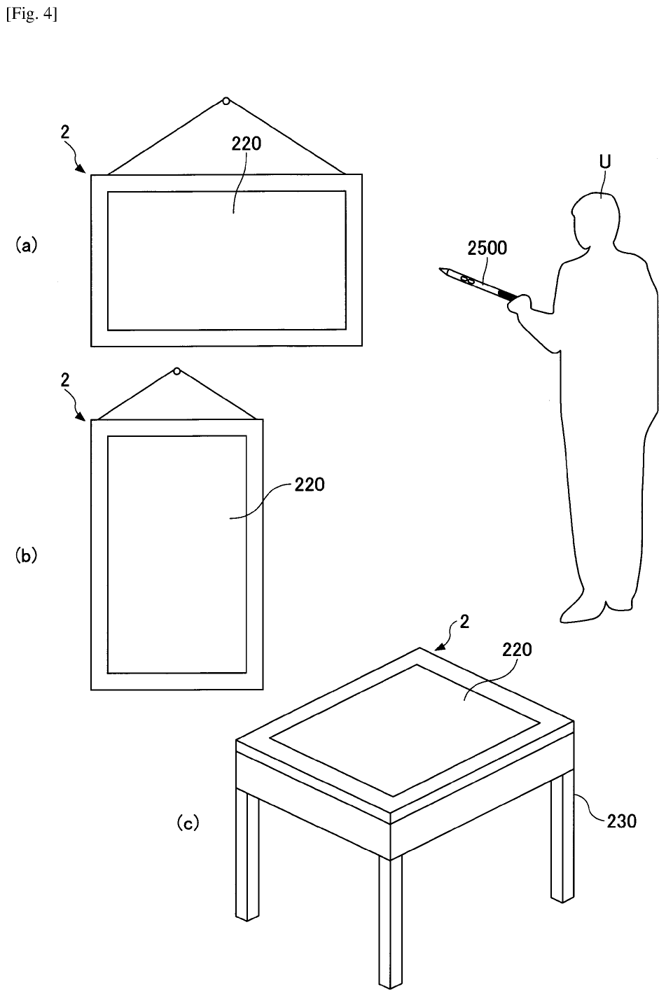

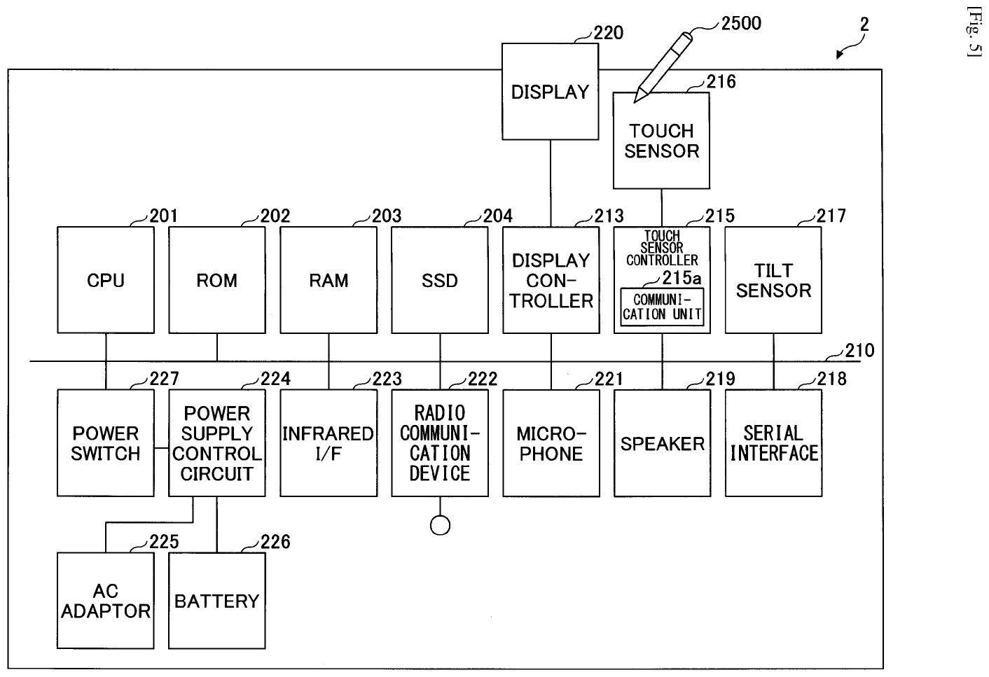

An overall configuration of the display apparatus 2 according to the present embodiment will be described with reference to FIG. 4. FIG. 4 is a diagram illustrating an overall configuration diagram of the display apparatus 2. In FIG. 4 (a), as an example of the display apparatus 2, the display apparatus 2 is used as an electronic blackboard that is horizontally long and is suspended on a wall.

As depicted in FIG. 4 (a), a display 220 as an example of a display device is installed on a front side of the display apparatus 2. A user U may handwrite (in other words, input or draw) characters or the like onto the display 220 using the pen 2500.

FIG. 4 (b) depicts the display apparatus 2 used as a vertically long electronic blackboard suspended on a wall.

FIG. 4 (c) depicts the display apparatus 2 placed flatly on a table 230. Because a thickness of the display apparatus 2 is about 1 cm, it is not necessary to adjust the height of the desk even if the display apparatus 2 is placed flatly on an ordinary desk. In addition, the display apparatus 2 can also be easily moved.

<Apparatus Hardware Configuration>

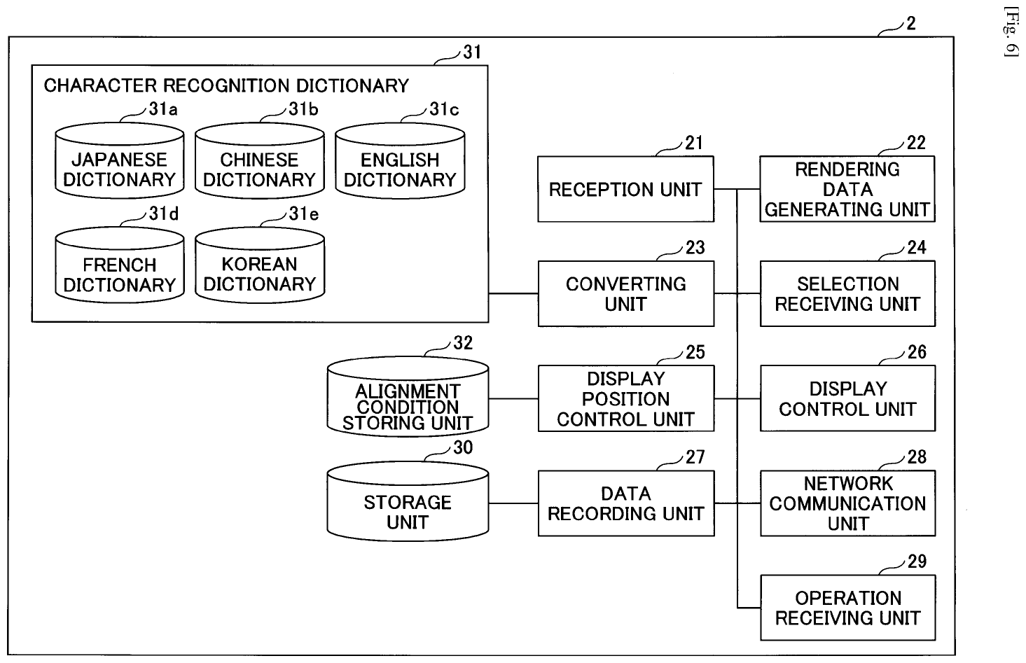

A hardware configuration of the display apparatus 2 will now be described with reference to FIG. 5. The display apparatus 2 has a configuration of an information processing apparatus or a computer as depicted. FIG. 5 is an example of a hardware configuration diagram of the display apparatus 2. As depicted in FIG. 5, the display apparatus 2 includes a central processing unit (CPU) 201, a read-only memory (ROM) 202, a random access memory (RAM) 203, and a solid state drive (SSD) 204.

The CPU 201 controls operations of the entire display apparatus 2. The ROM 202 stores programs such as an initial program loader (IPL) used to drive the CPU 201. The RAM 203 is used as a work area of the CPU 201. The SSD 204 stores various data such as a program for the display apparatus 2. The SSD 204 stores various data such as an OS and a program for the display apparatus 2. These programs may be application programs that are application programs operating on an information processing apparatus where a general-purpose operating system (Windows (registered trademark), Mac OS (registered trademark), Android (registered trademark), iOS (registered trademark), or the like) is installed.

The display apparatus 2 includes a display controller 213, a touch sensor controller 215, a touch sensor 216, the display 220, a power switch 227, a tilt sensor 217, a serial interface 218, a speaker 219, a microphone 221, a radio communication device 222, an infrared I/F 223, a power supply control circuit 224, an AC adapter 225, and a battery 226.

The display controller 213 controls and manages displaying a screen page to output an output image to the display 220. The touch sensor 216 detects that the pen 2500 or user's hand or the like (the pen or user's hand acts as the input unit) is in contact with the display 220. The touch sensor 216 receives the pen ID.

The touch sensor controller 215 controls processing of the touch sensor 216. The touch sensor 216 implements inputting of coordinates and detecting of the coordinates. A method for inputting coordinates and detecting the coordinates is, for example, in a case of optical type, a method in which two light emitting and receiving devices located at upper and lower edges of the display 220 emit a plurality of infrared rays parallel to the display 220 and are reflected by a reflecting member provided around the display 220 to receive light returning along the same optical path as the light originally emitted by the light emitting and receiving devices. The touch sensor 216 outputs position information of infrared emitted by the two light emitting and receiving devices and blocked by an object to the touch sensor controller 215, and the touch sensor controller 215 identifies the coordinate position that is the contact position of the object. The touch sensor controller 215 also includes a communication unit 215a that can communicate wirelessly with the pen 2500. For example, a commercially available pen may be used when communicating in a standard such as Bluetooth (registered tradename). When one or more pens 2500 are registered in the communication unit 215a in advance, a user can implement communication without performing a connection setting work that enables the pen 2500 to communicate with the display apparatus 2.

The power switch 227 is a switch for turning on and turning off of the power in the display apparatus 2. The tilt sensor 217 is a sensor that detects a tilt angle of the display apparatus 2. The tilt sensor 217 is used mainly to detect whether the display apparatus 2 is being used in the installation state of any one of FIG. 4 (a), FIG. 4 (b), or FIG. 4 (c). A thickness of letters or the like displayed on the display apparatus 2 can be automatically changed depending on the installation state.

The serial interface 218 is a communication interface such as a USB interface for an external device/apparatus, and is used for inputting information from an external device/apparatus. The speaker 219 is used for outputting a sound and the microphone 221 is used for inputting a sound. The radio communication device 222 communicates with a terminal held by a user, and then, is connected to, for example, the Internet via the terminal. The radio communication device 222 performs communications via Wi-Fi, Bluetooth, or the like, but there is no limitation to any particular communication standard. The radio communication device 222 acts as an access point, and it is possible to connect to the access point by setting a service set identifier (SSID) and a password, obtained by the user, to the terminal that the user holds.

The radio communication device 222 may have the following two access points:
(a) access point→Internet
(b) access point→internal network→Internet

The access point (a) is for an external user, and the user cannot access the internal network, but can use the Internet. The access point (b) is for an internal user, and the user can use the internal network and the Internet.

The infrared I/F 223 detects an adjacent display apparatus 2. Only the adjacent display apparatus 2 can be detected using rectilinearly advancing property of infrared rays. Preferably, the infrared I/F 223 is provided one by one on each of the four sides of the display apparatus 2, and it is possible to detect in which direction of the display apparatus 2 another display apparatus 2 is disposed. This can extend a display screen and thereby allows the adjacent display apparatus 2 to display handwritten information having been handwritten in the past (or handwritten information displayed on another page assuming that the size of one display 220 corresponds to one page), for example.

The power supply control circuit 224 controls the AC adapter 225 and the battery 226 that are power sources for the display apparatus 2. The AC adapter 225 converts an alternating-current (AC) power shared by the commercial power supply to a direct-current (DC) power.

In a case where the display 220 is what is known as electronic paper, the display 220 consumes little or no power to maintain displaying an image, so that the display 220 can be driven also by the battery 226. As a result, it is possible to use the display apparatus 2 for an application such as a digital signage even in a place where it is difficult to connect to a power source, such as an outdoor place.

The display apparatus 2 further includes a bus line 210. The bus line 210 may include an address bus, a data bus, and so forth for electrically connecting elements such as the CPU 201 depicted in FIG. 5.

The touch sensor 216 is not limited to an optical type one. Any one of various types of detection devices may be used, such as a touch panel of a capacitance type in which a contact position is identified by sensing a change in capacitance, a touch panel of a resistive film type in which a contact position is identified by a voltage change between two opposing resistive films, and an electromagnetic induction type touch panel in which electromagnetic induction generated when a contact object contacts a display unit is detected and a contact position is identified. The touch sensor 216 may be of a type not requiring an electronic pen to detect a presence or absence of a touch at the pen tip. In this case, a fingertip or a pen-shaped rod can be used for a touch operation. Note that the pen 2500 need not be of an elongated pen type.

<Functions>

Next, functions of the display apparatus 2 will be described with reference to FIG. 6. FIG. 6 is an example of a functional block diagram explaining functions of the display apparatus 2. The display apparatus 2 includes a reception unit 21, a rendering data generating unit 22, a converting unit 23, a selection receiving unit 24, a display position control unit 25, a display control unit 26, a data recording unit 27, a network communication unit 28, and an operation receiving unit 29. Each function of the display apparatus 2 is implemented as a result of one of the elements depicted in FIG. 5 being operated according to instructions sent from the CPU 201 according to a program loaded from the SSD 204 to the RAM 203.

The reception unit 21 detects coordinates of a position where the pen 2500 contacts the touch sensor 216. The reception unit 21 receives input of handwritten data based on the coordinates of the position.

The rendering data generating unit 22 obtains the coordinates at which the pen tip of the pen 2500 contacts the touch sensor 216 from the reception unit 21. The rendering data generating unit 22 connects each other a sequence of coordinate points by interpolating, and generates stroke data.

The converting unit 23 performs a character recognition process on one or more sets of stroke data (handwritten data) handwritten by a user and converts the data into text data (character code). Upon character recognition, a dictionary corresponding to a language registered in a character recognition dictionary 31 is used. The character recognition dictionary 31 has a dictionary corresponding to each of languages to which handwritten data is converted. In one embodiment, a dictionary used by the display apparatus 2 is set from a display screen by a user. In FIG. 6, a Japanese dictionary 31a, a Chinese dictionary 31b, an English dictionary 31c, a French dictionary 31d, and a Korean dictionary 31e are depicted as examples.

The converting unit 23 recognizes a character (not only of a Japanese language but also of a multilingual language such as English), a numerical digit, a symbol (%, $, &, or the like), a figure (a line, a circle, a triangle, or the like) concurrently with a user's pen operation. Various algorithms have been devised as character recognition methods. Concerning the present embodiment, details are omitted as well-known techniques are available.

Although depicted in a form of a dictionary in FIG. 6, each dictionary may be a neural network type recognition unit using, for example, deep learning, a convolutional neural network (CNN), and so forth. Specific learning methods for machine learning may be supervised learning, unsupervised learning, semi-supervised learning, reinforcement learning, or deep learning, or a combination of these learning methods, and thus, any learning method may be used for machine learning.

A specific machine learning technique to be used may be, but is not limited to, perceptron, deep learning, support vector machine, logistic regression, naive bayes, decision tree, random forest, or the like, and thus, is not limited to the technique described with regard to the present embodiment.

The selection receiving unit 24 receives a user's selection of a character string that is a part or the entirety of first text data. A selected string is referred to as a selected section character string. A selected section character string is enclosed by a bounding box. If a user moves the tip of the pen while touching a bounding box using the pen 2500 (also referred to as a pen movement or a dragging operation), the bounding box can be moved.

When first text data and handwritten data satisfy predetermined conditions, the display position control unit 25 aligns second text data with the first text data based on the position of the handwritten data generated by the rendering data generating unit 22. The predetermined conditions are stored in the alignment condition storing unit 32. Details will be described later.

The display control unit 26 displays handwritten data, character strings converted from handwritten data, an operation menu for a user to perform an operation, and the like.

The data recording unit 27 stores handwritten data written on the display apparatus 2 or converted text data in the storage unit 30. The data recording unit 27 may record a screen page displayed on a personal computer (PC), a displayed file, or the like, obtained by the display apparatus 2.

The network communication unit 28 connects to a network, such as a LAN, and transmits and receives data via the network with respect to another device/apparatus.

The storage unit 30 is implemented in the SSD 204 or the RAM 203 illustrated in FIG. 5 and stores the above-described information recorded by the data recording unit 27.

The storage unit 30 stores data depicted in Table 1 above. Table 1 (a) depicts page data conceptually. The page data includes data of each page of handwritten data displayed on the display.

As depicted in Table 1 (a), each set of page data is stored in association with a page data ID for identifying a page; a start time for indicating when displaying of the page was started; an end time for indicating when the contents of the page was no longer rewritten; a stroke sequence data ID for identifying stroke sequence data generated by a stroke of the pen 2500 or the user's hand or finger; and a medium data ID for identifying medium data such as image data.

Such page data is used to indicate, for example, a single alphabetical letter [S] with a single stroke data ID, for example, for a case where a user draws an alphabetical letter “S” with the pen 2500 through a single stroke. If a user draws an alphabetical letter “T” with the pen 2500, two sets of stroke data ID are used for representing a single alphabetical letter “T” because two strokes are needed to draw “T”.

Stroke sequence data provides detailed information as depicted in Table 1 (b). Table 1 (b) depicts stroke sequence data. One set of stroke sequence data includes multiple sets of stroke data. One set of stroke data includes a stroke data ID for identifying the set of stroke data, a start time indicating a time at which writing of the one set of stroke data was started (pen-down time), an end time indicating a time at which the writing of the one set of stroke data ended (pen-up time), a color of the one set of stroke data, a length of the one set of stroke data, coordinate sequence data ID for identifying a sequence of passing points with respect to the one set of stroke data, and a text ID for identifying text data into which the one set of stroke data was converted.

Pen-down refers to contacting of the input unit (the pen, user's hand, finger, etc.) on the display 220. Pen-down may also refer to a case where, although the input unit is not in contact with the display 220, a distance between the tip of the input unit and the display 220 becomes smaller than or smaller than or equal to a threshold. Pen-up refers to separating the input unit, having been in contact with the display 220, from the display 220. Pen-up may also refer to a state where a distance between the tip of the input unit and the display 220 becomes greater than or greater than or equal to a threshold. Pen movement refers to a user moving the input unit, while the input unit is in contact with the display 220, to move the contact position with the display 220.

Because multiple sets of stroke data can be converted into a single set of text data, the same text ID is associated with multiple stroke data IDs in Table 1 (b). Information concerning each of these sets of text data is depicted in Table 1 (d). A “text ID” field for stroke data that was not recognized as a character is left blank. Stroke data provided with a text ID is at least not displayed. Stroke data provided with a text ID may be deleted.

Table 1 (c) depicts coordinate sequence data. As depicted in Table 1 (c), coordinate sequence data depicts a point on the display (a x-coordinate value and a y-coordinate value), a time difference (ms) of a time when the input unit passed through the point from a time when writing of stroke was started, and a pen pressure of the pen 2500 at the point. That is, a collection of points depicted in Table 1 (c) is depicted as a single set of coordinate sequence data depicted in Table 1 (b). For example, if a user draws an alphabetical letter “S” by the pen 2500, the letter is drawn through a single stroke, but corresponding coordinate sequence data includes information for multiple points because the input unit passes through the multiple points to drawn the letter the “S”.

Table 1 (d) depicts text data information. The converting unit 23 recognizes stroke data as a character and converts the stroke data into text data. Text data selected by a user from character string candidates that will be described below or text data determined by the display apparatus 2 by itself is stored as text data information. A set of text data information is thus stored and is associated with a text ID (a character code), coordinates (at an upper left corner of a circumscribing rectangle and a lower right corner of the circumscribing rectangle), a font, a size, and a color. The term “corner” refers to a corner or vertex of an area defined by a rectangle. Text data may be stored on a per character recognition basis or on a per character basis. Table 1 (d) is on a per character recognition basis. What is stored each time on a per character recognition basis depends on how many characters you have handwritten from a time of pen-down to a time of pen-up (actually, to a time when a pen-up state continues for a time longer than or equal to a certain time).

TABLE 2
PREDETERMINED CONDITIONS

| | |
|---|---|
| 1 | DISTANCE BETWEEN MUTUALLY NEAREST |
| | RESPECTIVE POINTS OF FIRST TEXT DATA AND |
| | SECOND TEXT DATA IS SMALLER THAN THRESHOLD |
| | (OR IS SMALLER THAN OR EQUAL TO THRESHOLD) |
| 2 | FIRST TEXT DATA AND SECOND TEXT |
| | DATA OVERLAP WHEN VIEWED IN |
| | HORIZONTAL DIRECTION OR VERTICAL DIRECTION |

Table 2 depicts the predetermined conditions for alignment, stored in the alignment condition storing unit 32. The predetermined conditions are as follows:
(i) A distance between mutually nearest respective points of first text data and handwritten data is smaller than (or smaller than or equal to) a threshold
(ii) First text data and handwritten data overlap when viewed in a horizontal direction or a vertical direction

Although these two predetermined conditions (i) and (ii) are AND conditions (i.e., the display apparatus 2 aligns the sets of two text data in response to the two conditions (i) and (ii) are satisfied concurrently), the predetermined conditions may be used as OR conditions to determine whether the display apparatus 2 aligns the sets of two text data (i.e., the display apparatus 2 aligns the sets of two text data in response to either one of the two conditions (i) and (ii) being satisfied or the two conditions are satisfied concurrently). Also, conditions other than the above-described conditions (i) and (ii) may be additionally used.

<Example of Selectable Candidates>

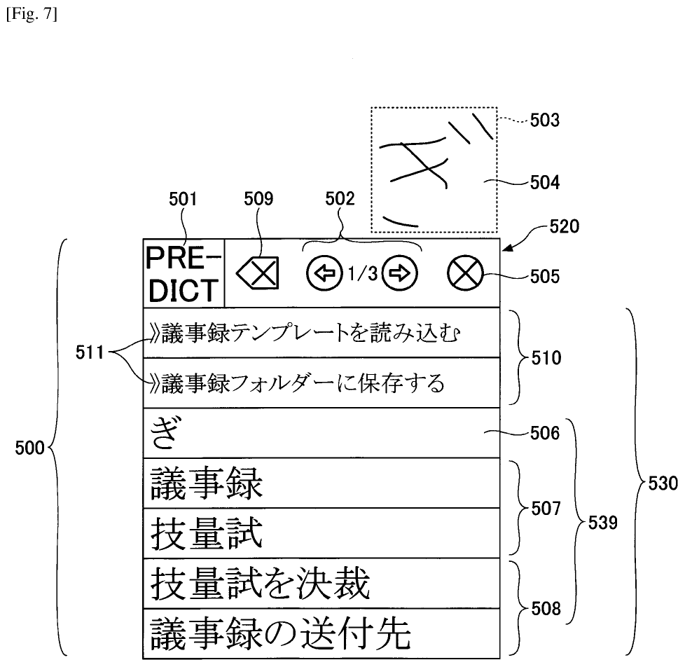

Next, an operation guide 500 displayed at a time of converting handwritten data will be described with reference to FIG. 7. FIG. 7 depicts an example of the operation guide 500 and selectable candidates 530 displayed in the operation guide 500. The operation guide 500 is displayed in response to a user handwriting handwritten data 504, performing a pen-up operation, and then, not performing a pen-down operation for a certain period of time.

The operation guide 500 includes an operation header 520, operation command candidates 510, a handwritten recognized character string candidate 506, converted character string candidates 507, character string/predictively converted candidates 508, and a handwritten data display rectangular area 503. The selectable candidates 530 include the operation command candidates 510, the handwritten recognized character string candidate 506, the converted character string candidates 507, and the character string/predictively converted candidates 508. Character string candidates other than the operation command candidates 510 from among the selectable candidates 530 are referred to as character string candidates 539.

The operation header 520 has buttons 501, 509, 502, and 505. A button 501 receives a user's operation to switch between predictive conversion and kana conversion. In the example of FIG. 7, when a user clicks the button 501 labeled “PREDICT”, the operation receiving unit 29 receives the user's operation, and the display control unit 26 changes the display of the button “PREDICT” to a button “KANA”. After the change, the character string candidates 539 are arranged in a descending probability order with respect to “kana conversion”.

A button 502 is for a user to operate candidate display pages. In the example of FIG. 7, the candidate display pages include three pages, and now, a first page is displayed. A button 505 is for a user to erasure of the operation guide 500. When a user presses the button 505, the operation receiving unit 29 receives the operation and the display control unit 26 erases the displayed contents other than handwritten data. A button 509 is to perform collective display deletion. When a user presses the button 509, the operation receiving unit 29 receives the operation and the display control unit 26 erases all the display contents depicted in FIG. 7 including the handwritten data, to allow the user to again handwrite from the beginning.

The handwritten data 504 is a letter
“ [symbol] ”

(a “Hiragana” letter) handwritten by a user. The handwritten data display rectangular area 503 including the handwritten data 504 is displayed. In FIG. 7, the operation guide 500 is displayed in response to the single letter being input, but a timing at which the operation guide 500 is displayed is when a user has suspended handwriting. Therefore, the number of characters of the handwritten data 504 can be freely determined by the user.

The handwritten recognized character string candidate 506, the converted character string candidates 507, and the character string/predictively converted candidates 508 are arranged in a descending probability order. The handwritten recognized character string candidate 506
“ [symbol] ”

is a candidate for a recognition result. In this example,
“ [symbol] ”

has been correctly recognized.

The converted character string candidates 507 are converted character string candidates (for example, a phrase including
“ [symbol] ”

(meaning “technology”)) converted from a result of kana-kanji conversion (e.g.,
“ [symbol] ”

(that has a pronunciation “gi”)) from
“ [symbol] ”
   (that also has the same pronunciation “gi”). In this example, a phrase
“ [symbol] ”
   is an abbreviation for a phrase
“ [symbol] ”
   (meaning “technical mass production trial”). The character string/predictively converted candidates 508 are predicted character string candidates converted from the converted character string candidates 507. In this example,
“ [symbol] ”
   (meaning to “approve the technical mass production trial”) and
“ [symbol] ”
   (meaning “a transmission destination of meeting minutes”) are displayed.

The operation command candidates 510 are candidates for a predefined operation command (e.g., a command to operate a file, a command to edit characters, etc.) that are displayed depending on a recognized character. In the example of FIG. 7, a character or a mark to be added at a line head
“ [symbol] ”

511 is indicated as being a candidate for an operation command. In FIG. 7,
“ [symbol] [symbol] ”

(meaning to “read a meeting minutes template”) and
“ [symbol] [symbol] ”

(meaning to “save in the meeting minutes folder”) are displayed as the operation command candidates 510 because each of these two sets of letters included in the predefined operation command data partially matches with the character string candidate
“ [symbol] ”

(meaning “meeting minutes”) that is a character string candidate with respect to
“ [symbol] ”.

“A character or a mark to be added at a line head” is a character or a mark to be added at a head of a paragraph or a head of text.

When a user selects
“ [symbol] [symbol] ”,

the corresponding command included in the predefined data is executed. As described above, an operation command candidate is displayed when corresponding operation command predefined data including a converted character string is found. Therefore, such an operation command candidate is not always displayed.

As depicted in FIG. 7, the character string candidates and the operation command candidates are displayed at the same time (together), so that the user can select either a character string candidate or an operation command candidate the user wishes to input.

<Examples of Predetermined Conditions>

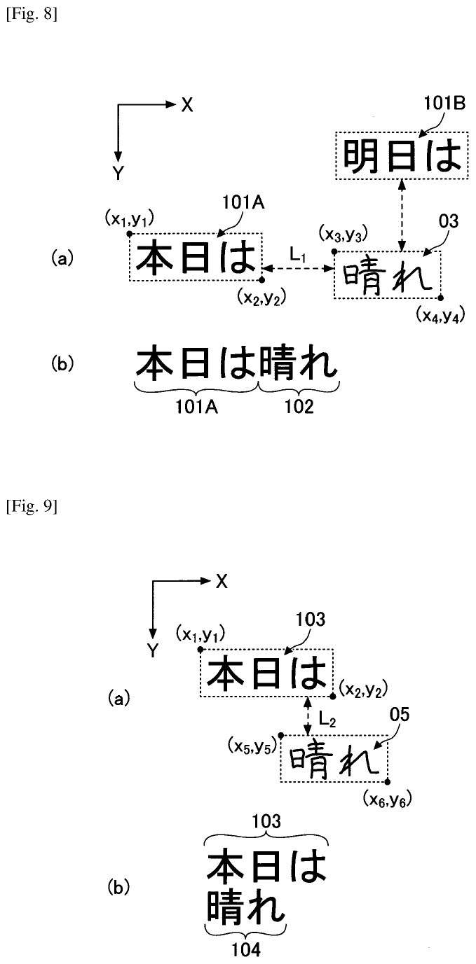

Referring now to FIG. 8, the predetermined conditions for the display apparatus 2 to align second text data with first text data will be now described. FIG. 8 is an example of a diagram illustrating the predetermined conditions. Hereinafter, unless otherwise noted, processing after a user selects a character string candidate 539 or after text data with the highest probability is automatically displayed without the operation guide 500 being displayed will be described. When a conversion target is limited to a numerical digit or the like, the display apparatus 2 can convert a conversion target with almost no erroneous conversion. In this case, because the operation guide 500 is not displayed, the input efficiency can be improved for a case where, for example, a numerical digit will be input.

In FIG. 8 (a), two sets of first text data 101A and 101B and handwritten data 03 are displayed. The handwritten data 03 is converted into second text data.

The display position control unit 25 identifies the first text data 101A for which a distance from the handwritten data 03 is the smallest among all of the two sets of first text data 101A and 101B. Then, the display position control unit 25 detects a distance between nearest respective points of a circumscribing rectangle of the text data 101A and a circumscribing rectangle enclosing the handwritten data 03. In FIG. 8 (a), the first text data 101A (
“ [symbol] ”)

is identified. Alternatively, the display position control unit 25 may first focus on the handwritten data 03, and then, identify the first text data 101A that is nearest to the handwritten data 03.

Next, the display position control unit 25 determines whether the distance L1 between the first text data 101A and the handwritten data 03 is smaller than a threshold (or is smaller than or equal to the threshold). When the distance L1 is smaller than the threshold (or smaller than or equal to the threshold), the display position control unit 25 determines whether the first text data 101 and the handwritten data 03 overlap when viewed in a horizontal direction or a vertical direction. In FIG. 8 (a), the coordinates of the upper left corner of the circumscribing rectangle of the first text data 101A are (x₁, y₁) and the coordinates of the lower right corner are (x₂, y₂). Therefore, it is determined that the first text data 101 and the handwritten data 03 overlap when viewed in a horizontal direction, when y₁ or y₂ falls within the height (between y₃ and y₄) of the circumscribing rectangle of the handwritten data 03, i.e., is greater than or equal to y₃ and smaller than or equal to y₄.

The display position control unit 25 may not only determine whether the first text data 101A overlaps with the handwritten data 03 at least in part, but may add an overlap rate to the predetermined conditions. A rate of overlapping when viewed in a horizontal direction is calculated as (y₂−y₃)/(y₂−y₁) for a case of y₁<y₃<y₂ and is calculated as (y₄−y₁)/(y₂−y₁) for a case of y₁<y₄<y₂, for example. In this case, the display position control unit 25 determines that the predetermined condition (ii) is satisfied when the two sets of text data overlap when viewed in a horizontal direction and the overlap rate is greater than or equal to a threshold (or is greater than the threshold).

In FIG. 8 (a), the display position control unit 25 determines that the first text data 101A and the handwritten data 03 overlap when viewed in a horizontal direction. When the display position control unit 25 thus determines that overlapping when viewed in a horizontal direction occurs, second text data 102 that is converted from the handwritten data 03 is continuously displayed without a space (a “space” means a space that is used to represent a word separation or a space from another character) at the right edge of the first text data 101A, using text data information depicted in Table 1 (d). More specifically, the display position control unit 25 causes the upper right corner of the circumscribing rectangle of the first text data 101A to be coincident with the upper left corner of the circumscribing rectangle of the second text data 102, and causes the lower right corner of the circumscribing rectangle of the first text data 101A to be coincident with the lower left corner of the circumscribing rectangle of the second text data 102, when displaying the second text data 102. FIG. 8 (b) depicts the second text data 102 aligned with the first text data 101A. As described above, the display position control unit 25 controls a display position of the second text data 102 based on the position of the first text data 101A.

Here, a character size of text data is automatically determined according to a size of a circumscribing rectangle of handwritten data. Therefore, a size of the first text data 101A does not necessarily correspond to a size of the second text data 102. Therefore, the display position control unit 25 desirably sets a character size of the second text data 102 to be the same as a character size of the first text data 101A. For this purpose, the display position control unit 25 obtains the character size of the first text data 101A from the text data information of Table 1 (d) and applies the character size of the first text data 101A to the character size of the second text data 102. This allows the display apparatus 2 to display aligned text data for a user to easily read.

Also with regard to a font, the display position control unit 25 desirably makes a font of the second text data 102 to be the same as a font of the first text data 101A. As supplemental information, the display apparatus 2 has a default font. If a user does not select a font, the default font is used. However, if a user freely selects a font of the first text data 101A, the font of the first text data 101A may differ from the font (default) of the second text data 102. In view of this point, the display position control unit 25 obtains a font of the first text data 101A from the text data information of Table 1 (d) and sets the font as a font of the second text data 102. This can cause respective fonts of aligned sets of text data to be the same as one another. The display position control unit 25 can process respective colors of aligned sets of text data in the same manner.

However, the display apparatus 2 does not need to cause a size, a font, and a color of the second text data to be the same as a size, a font, and a color of the first text data. For example, if the sizes are not the same, the display position control unit 25 aligns a lower edge the first text data with a lower edge of the second text data, when displaying the second text data. Alternatively, the display position control unit 25 may align a center (with respect to the height direction) of the first text data with a center (with respect to the height direction) of the second text data when displaying the second text data.

In FIG. 8, the second text data 102 is aligned with the first text data 101A in a manner in which the display position control unit 25 moves the second text data 102 leftward. However, when the first text data 101A is on a right side of the handwritten data 03, the display position control unit 25 moves the second text data 102 rightward. In the case of horizontal writing, if the second text data 102 is connected on the left side of the first text data 101A, the meaning of the sentence may be erroneous. Therefore, a user may select leftward moving alignment only, rightward moving alignment only, or both, by performing a corresponding setting.

As depicted in FIG. 9, the display position control unit 25 can perform the same processing even when overlapping when viewed in a vertical direction occurs. FIG. 9 depicts an example of a diagram illustrating alignment in a case of overlapping when viewed in a vertical direction. The display position control unit 25 determines a distance L2 between a circumscribing rectangle of first text data 103 and a circumscribing rectangle of handwritten data 05. Then, it is determined whether the distance L2 is smaller than a threshold (or is smaller than or equal to the threshold).

When the distance L2 is smaller than the threshold (or is smaller than or equal to the threshold), the display position control unit 25 determines whether the first text data 103 and the handwritten data 05 overlap when viewed in a horizontal direction or a vertical direction. In FIG. 9 (a), the coordinates of the upper left corner of the circumscribing rectangle in the first text data 103 are (x₁, y₁) and the coordinates of the lower right corner of the circumscribing rectangle in the first text data 103 are (x₂, y₂). Therefore, the display position control unit 25 determines that overlapping when viewed in a vertical direction occurs when x₁ or x₂ falls within the width (between x₅ and x₆) of the circumscribing rectangle of the handwritten data 05, i.e., is greater than or equal to x₅ and smaller than or equal to x₆. In FIG. 9 (a), it is determined that overlapping when viewed in a vertical direction occurs.

When the display position control unit 25 determines that overlapping when viewed in a vertical direction occurs, the display position control unit 25 displays the second text data 104 next to the lower edge of the first text data 103 as a new line with respect to the first text data 103 using the text data information depicted in Table 1 (d). The second text data 104 has been converted from the handwritten data 05. Displaying as a new line means a line change from a current line to a next line. Upon displaying the second text data as a new line with respect to the first text data, the second text data is displayed from the beginning of the new line with respect to the line of the first text data. However, because the display apparatus 2 according to the present embodiment does not particularly employ a concept of a “line” (i.e., a user can perform horizontal writing at any position), the second text data is displayed, through alignment, below the first text data.

More specifically, the display position control unit 25 displays the left edge of the second text data 104 in alignment with the left edge of the first text data 103 next to the lower edge of the first text data 103 without a line space from the line of the first text data 103. Therefore, the display position control unit 25 causes the lower left corner of the first text data 103 to be coincident with the upper left corner of the second text data 104. FIG. 9 (b) depicts the second text data 104 aligned below the first text data 103.

The display position control unit 25 may place the first text data 103 and the second text data 104 with a space between these two sets of text data. The thus aligned sets of text data are easier to see. A user may set whether the space is inserted or a size of the space, or a combination of these items.

In the example of FIG. 9, the display position control unit 25 aligns the second text data 104 below the first text data 103. However, when the first text data 103 is present on the lower side of the handwritten data 05, the display position control unit 25 displays the second text data 104 above the first text data 103. Alternatively, a user may be able to set an alignment direction to a lower direction only, an upper direction only, or both.

<<Supplemental Description for Vertical Writing>>

In the alignment methods of FIGS. 8 and 9, the display position control unit 25 aligns the second text data at the position shifted in the left direction with respect to the original handwritten data, on the assumption that the text data is of horizontal writing. However, in a case of vertical writing, different alignment methods are used.

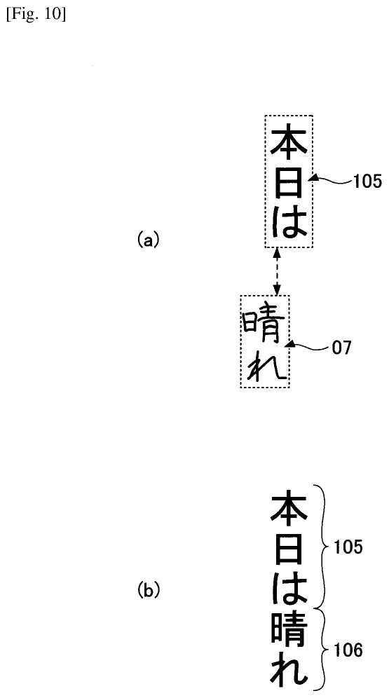

FIG. 10 is a diagram for describing an alignment method when first text data 105 is of vertical writing and handwritten data 07 overlaps with the first text data 105 when viewed in a vertical direction. The predetermined conditions are the same as the predetermined conditions described above for horizontal writing. However, when the display position control unit 25 determines that the predetermined conditions are satisfied, a different alignment method is used. In FIG. 10 (a), it is determined that the first text data 105 and the handwritten data 07 overlap when viewed in a vertical direction. In this case, the display position control unit 25 continuously displays the second text data 106 converted from the handwritten data 07 without a space next to the lower edge of the first text data 105, using the text data information of Table 1 (d).

More specifically, the display position control unit 25 causes the upper left corner of the second text data 106 converted from the handwritten data 07 to be coincident with the lower left corner of the first text data 105, and causes the lower right corner of the second text data 106 to be coincident with the lower right corner of the first text data 105. FIG. 10 (b) depicts the second text data 106 vertically aligned with the first text data 105.

When the handwritten data 07 is located on the upper side of the first text data 105, the display position control unit 25 continuously displays the second text data 106 converted from the handwritten data 07 without a space next to the upper edge of the first text data 105. A user may select to align only on the upper side, only on the lower side, or both, through a setting.

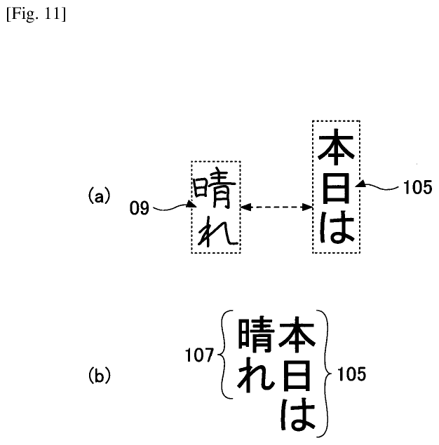

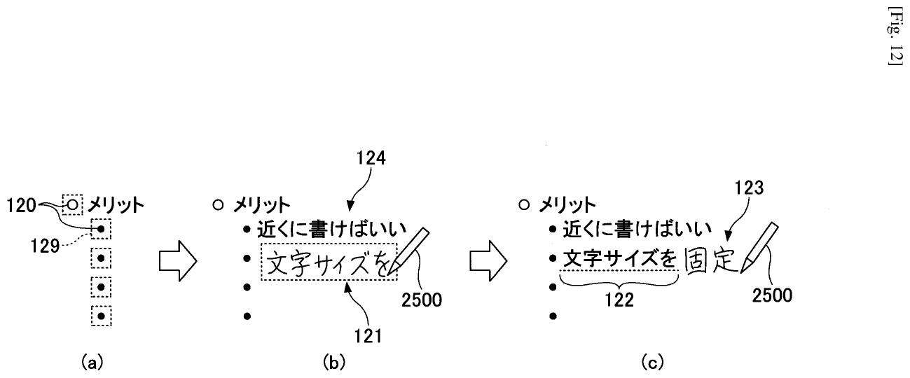

FIG. 11 is a diagram illustrating a method of alignment when the first text data 105 is of vertical writing and the first text data 105 overlaps with the handwritten data 09 when viewed in a horizontal direction. The predetermined conditions are the same as the predetermined conditions for horizontal writing. In the example of FIG. 11 (a), it is determined that the first text data 105 and the handwritten data 09 overlap when viewed in a horizontal direction. In this case, the display position control unit 25 displays the second text data 107 converted from the handwritten data 09 on the left side of the first text data 105 as a new line with respect to the first text data 105 by using the text data information of Table 1 (d).

More specifically, the display position control unit 25 displays the upper edge of the second text data 107 in alignment with the upper edge of the first text data 105 without a line space next to the left edge of the first text data 105. Thus, the display position control unit 25 causes the upper left corner of the first text data 105 to be coincident with the upper right corner of the second text data 107 converted from the handwritten data 09. FIG. 11 (b) depicts the second text data 107 aligned on the left side of the first text data 105.

When the handwritten data 07 is present on the right side of the first text data 105, the display position control unit 25 displays the second text data 107 converted from the handwritten data 07 without a line space next to the right edge of the first text data 105. The first text data 105 is thus placed as a new line with respect to the second text data 107. A user may select an alignment destination to only the right side, only the left side, or both, depending on a setting.

As described above, the display apparatus 2 can align the second text data with respect to the first text data, regardless of horizontal writing or vertical writing.

A user can set whether the user performs vertical writing or horizontal writing from the menu. Alternatively, the display apparatus 2 can automatically determine based on the handwritten data (i.e., whether the direction of handwriting is vertical or horizontal). The display apparatus 2 controls (switches) an alignment method according to whether the handwritten direction is vertical or horizontal.

<Variation of First Text Data>

The first text data is not limited to letters. The first text data may be anything displayed on the display.

FIG. 12 is a diagram illustrating a method of alignment when a character or a mark to be added at a line head for an item-by-item writing style corresponds to the first text data. Hereinafter, “a character or a mark to be added at a line head” may be referred to simply as “a line-head symbol”. A user performs an operation of displaying line-head symbols. As a result, as depicted in FIG. 12 (a), the display apparatus 2 displays line-head symbols 120. A method for displaying a line-head symbol 120 may be of, for example:
a user handwriting the line-head symbol,
a user displaying a template for the line-head symbol, or
a user selecting an item-by-item writing mode from the menu.

In FIG. 12 (a), line-head symbols 120
“◯”

and
“●”
   are displayed. The display position control unit 25 regards the line-head symbols 120 as first text data. Line-head symbols are also text data displayed before handwritten data, converted to second text data, is input.

A user wants to perform item-by-item writing so the user handwrites on the right side of line-head symbols 120. In FIG. 12 (b), handwritten data 121
“ [symbol] ”

(meaning “a character size”) is displayed. The display position control unit 25 identifies a line-head symbol nearest to the handwritten data 121 from among all of the line-head symbols 120. A circumscribing rectangle with respect to a line-head symbol has a size that corresponds to a size of the line-head symbol. In FIG. 12 (a), a circumscribing rectangle 129 is depicted, depending on a size, for each of the line-head symbols. The circumscribing rectangles 129 are not actually displayed. Thus, the display position control unit 25 can align second text data 122, into which the handwritten data 121 is converted, with a corresponding line-head symbol as in a case where first text data is text data other than a line-head symbol.

Note that, with respect to FIG. 12, the word
“ [symbol] ”

means “advantages”; the words
“ [symbol] ”

mean that “what is needed is to write within a short distance”; and the words
“ [symbol] ”

mean to “make a character size uniform”.

FIG. 12 (c) depicts a state in which the handwritten data 121 of FIG. 12 (b) is converted into second text data 122 and is aligned with the line-head symbol 120. Thus, by handwriting on the right side of the line-head symbol 120, the user can display the second text data 122 on the right side of the line-head symbol 120.

In FIG. 12 (b), the handwritten data 121 overlaps with the line-head symbol 120 when viewed in a horizontal direction, and also overlaps with the text data 124 on the upper side of the handwritten data 121 when viewed in a vertical direction. In this case, the display position control unit 25 regards the line-head symbol as taking precedence as first text data over the other characters.

Now, as depicted in FIG. 12 (c), a case in which a user handwrites handwritten data 123
“ [symbol] ”
   will be described. In this case, the display position control unit 25 regards the second text data 122 as first text data because there is no line-head symbol 120 of a distance smaller than a threshold (or smaller than or equal to the threshold) from the handwritten data 123. The display position control unit 25 aligns second text data converted from the handwritten data 123 with the second text data 122.

<Alignment with Respect to English>

Japanese is often written in an “on-a-per-word-basis space not inserting manner” where there is no space between words, but, in English and other languages, an “on-a-per-word-basis space inserting manner” is common where there is a space between words. An “on-a-per-word-basis space not inserting manner” refers to a writing manner where there is no space on a per certain unit basis in a sentence. An “on-a-per-word-basis space inserting manner” refers to a writing manner where a sentence is separated on a per certain unit basis with a space between certain units. Therefore, depending on a language, the display position control unit 25 needs to or does not need to insert a space during alignment. On the other hand, the display position control unit 25 does not need to insert a space between characters included in a word even in a case of writing in an on-per-word-basis space inserting language. For this reason, in a case of handwriting in an on-per-word-basis space inserting language, the display position control unit 25 determines whether second text data converted from the handwritten data is a word or a character, and determines whether to insert a space. In other words, the display position control unit 25 may determine whether to insert a space by identifying a language of text data converted from handwritten data. A “language” comprises conventions or rules for expressing, communicating, receiving, or understand information such as a person's will, thoughts, or feelings, using speech or written characters.

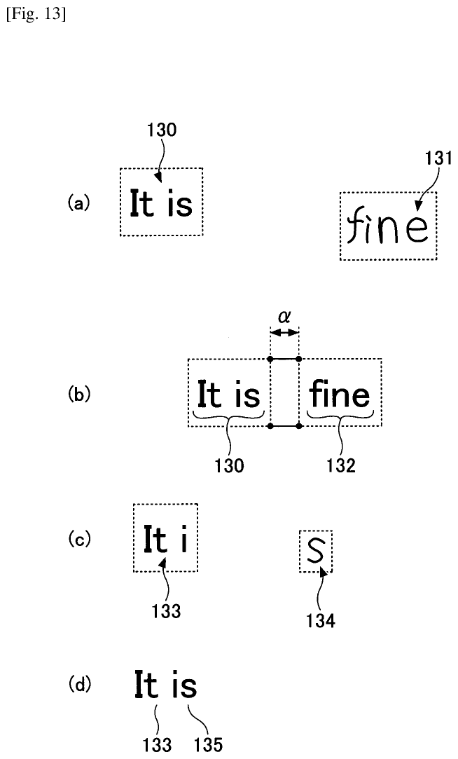

FIG. 13 is a diagram illustrating an alignment method in a case of English. In FIG. 13 (a), the display position control unit 25 determines that first text data 130 “It is” and handwritten data 131 “fine” overlap when viewed in a horizontal direction. The display position control unit 25 searches for “fine” which is second text data 132 converted from handwritten data 131 “fine” using a corresponding word dictionary. A word dictionary is a dictionary in which general words are registered, and the display apparatus 2 can use general dictionaries as the word dictionaries. The word dictionary may reside on the network.

Because it is determined from the search that “fine” is registered in the word dictionary, the display position control unit 25 determines that a space is input between the first text data 130 and the second text data 132. FIG. 13 (b) depicts the second text data 132 aligned with the first text data 130 with a space inserted between these two data sets.

“Inserting a space” refers to an operation of the display position control unit 25 to dispose the second text data 132 with a space corresponding to one character inserted after the first text data 130. Accordingly, the display position control unit 25 uses “an x-coordinate of the upper right corner of the first text data 130+α” as an x-coordinate of the upper left corner of the second text data 132. Similarly, the display position control unit 25 uses “an x-coordinate of the lower right corner of the first text data 130+α” as an x-coordinate of the lower left corner of the second text data 132. A y-coordinate of the second text data 132 may be the same as a y-coordinate of the first text data 130.

On the other hand, as depicted in FIG. 13 (c), the display position control unit 25 determines that first text data 133 “It i” and handwritten data 134 “s” overlap when viewed in a horizontal direction. The display position control unit 25 searches for “s”, which is second text data 135 converted from the handwritten data 134 “s”, from the word dictionary. Because it is determined from the search that “s” (a letter) is not registered in the word dictionary, the display position control unit 25 determines that a space is not inserted between the first text data 133 and the second text data 135. In this case, the method of alignment is the same as the method of alignment for an “on-a-per-word-basis space not inserting writing” manner. FIG. 13 (d) depicts the second text data 135 with the first text data 133 without a space between these two data sets.

Thus, the display position control unit 25 can implement alignment with respect to an on-a-per-word-basis space inserting language using a word dictionary to determine whether second text data corresponds to a word.

<Operation Procedure>

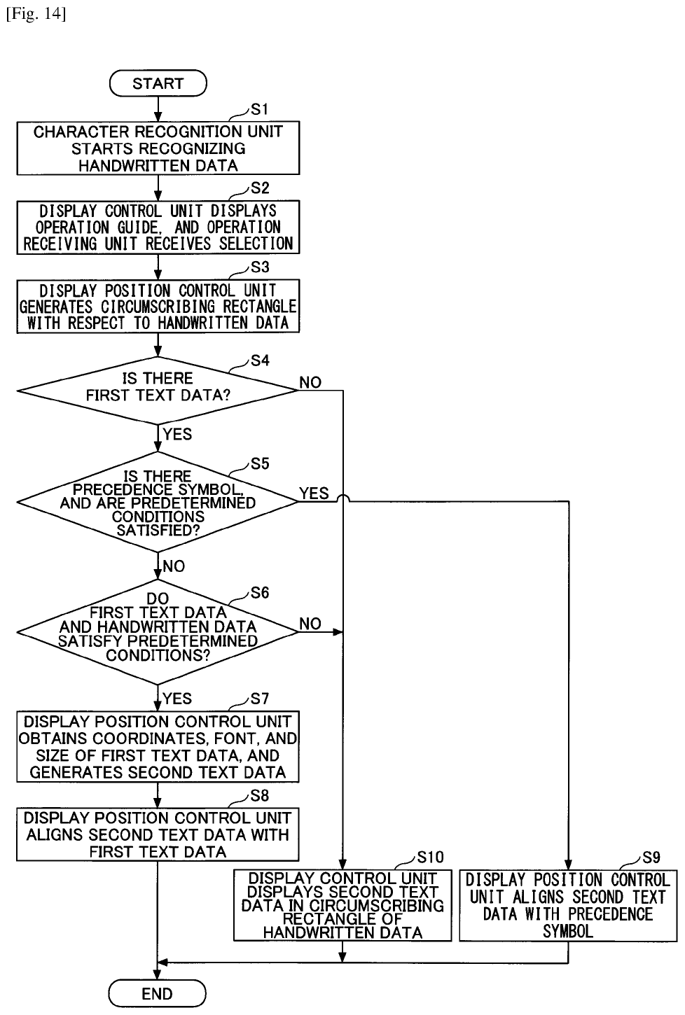

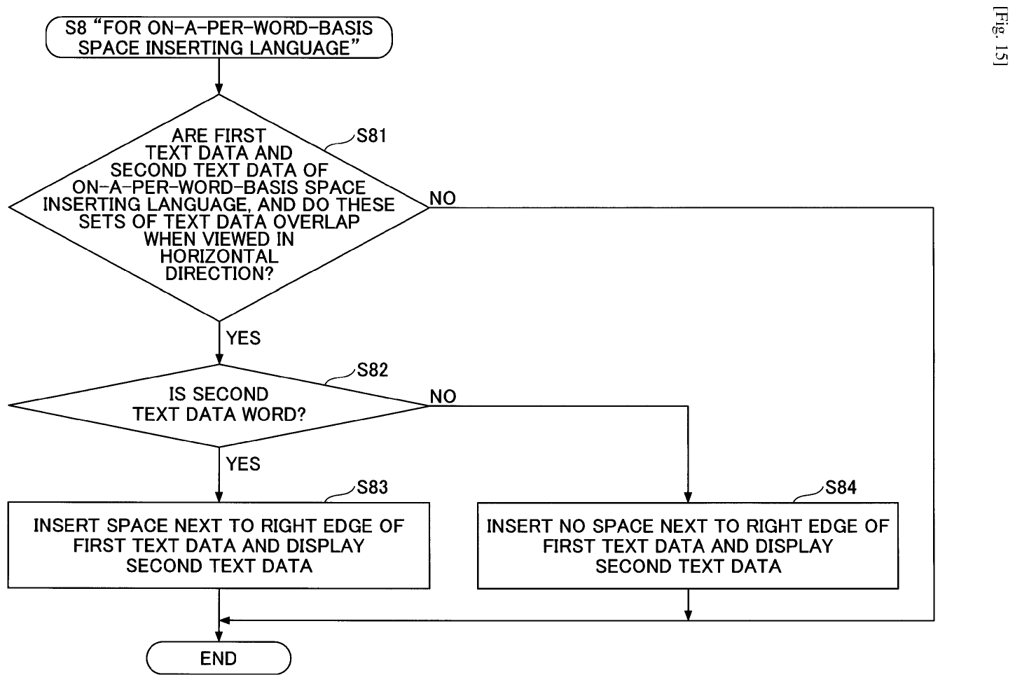

FIG. 14 is an example of a flowchart illustrating a process in which the display apparatus 2 aligns second text data with first text data. The process of FIG. 14 starts from a time when a user handwrites one or more strokes.

First, the converting unit 23 starts recognizing handwritten data (step S1). As a result, the converting unit 23 generates a character code of second text data. Now assume that the user performs a pen-up operation and then, a certain period of time has elapsed.

The display control unit 26 displays the operation guide 500 and the operation receiving unit 29 receives a selected character string candidate 539 through a corresponding user operation (step S2).

Next, the display position control unit 25 obtains a circumscribing rectangle with respect to the handwritten data in order to determine whether alignment is necessary (step S3).

Next, the display position control unit 25 determines whether first text data exists (step S4). That is, it is determined whether the handwritten data of step S1 is first handwritten data written on the page, that is, for example, whether the handwritten data of step S1 is handwritten by the user immediately after the start of the display apparatus 2. In order to implement the determination, the display position control unit 25 may refer to the text data information of Table 1 (d).

When the determination result of step S4 is No, the display position control unit 25 cannot align the second text data. Therefore, the display control unit 26 displays the second text data in the circumscribing rectangle with respect to the handwritten data (step S10).

When the determination result of step S4 is Yes, the display position control unit 25 determines whether a precedence symbol exists and the predetermined conditions are satisfied (step S5). A “precedence symbol” refers to first text data, which is to take precedence for being used for alignment, such as a line-head symbol. Precedence symbols are previously set with respect to the display position control unit 25. Instead, rather first text data and second text data, which are not to be used for alignment even if the predetermined conditions are satisfied, may be previously set.

When the determination result of step S5 is Yes, the display position control unit 25 aligns the second text data with the precedence symbol (step S9).

When the determination result of step S5 is No, the display position control unit 25 determines whether the first text data (that is the first text data determined in step S4 as existing) and the handwritten data satisfy the predetermined conditions (step S6). The display position control unit 25 identifies a set of first text data nearest to the handwritten data. The display position control unit 25 determines whether the distance between respective circumscribing rectangles of the identified set of first text data and the handwritten data is smaller than the threshold (or is smaller than or equal to the threshold) and the first text data and the circumscribing rectangle of the handwritten data overlap when viewed in a horizontal direction or a vertical direction. When the determination result of step S6 is No, the process proceeds to step S10.

When the determination result of step S6 is Yes, the display position control unit 25 obtains coordinates, a font, and a size of the first text data from the text data information of Table 1 (d). The display position control unit 25 generates second text data by applying the font and the size obtained from the text data information to a character code of the second text data (step S7).

Next, the display position control unit 25 aligns the second text data with the first text data (step S8). That is, the display position control unit 25 uses the coordinates of the first text data to continuously display the second text data converted from the handwritten data without a space next to the right edge of the first text data. Alternatively, the display position control unit 25 displays the second text data below the first text data as a new line with respect to the first text data using the coordinates of the first text data. That is, the display position control unit 25 controls the display position of the second text data based on the position of the first text data.

In order for step S8 to be suitable for an on-a-per-word-basis space inserting language, a process of FIG. 15 is to be performed by the display position control unit 25. FIG. 15 is an example of a flowchart illustrating a process of aligning second text data with first text data in a case of an on-a-per-word-basis space inserting language.

The display position control unit 25 determines whether the first text data and the second text data are of an on-per-word-basis space inserting language and overlap when viewed in a horizontal direction (step S81). When these two text data sets overlap when viewed in a vertical direction, the display position control unit 25 does not need to insert a space before displaying the second text data.

When the determination result of step S81 is Yes, the display position control unit 25 further determines whether the second text data is a word by referring to the word dictionary (step S82).

When the determination result of step S82 is Yes, the display position control unit 25 displays the second text data after inserting a space next to the right edge of the first text data (step S83).

When the determination result of step S83 is No, the display position control unit 25 continuously displays the second text data without inserting a space next to the right edge of the first text data (step S84).

Thus, the display apparatus 2 can align the second text data with the first text data, even in the case of an on-a-per-word space inserting language.

<Major Advantageous Effects>

As described above, when the predetermined conditions are satisfied, the display apparatus 2 according to the present embodiment can display another set of text data based on a position of one set of text data. That is, the two sets of text data can be aligned together. Two semantically linked sets of text data are thus displayed in alignment, making the text data easier for a user to read. Further, the display apparatus 2 can perform the same processing as line feed processing of word-processor software.

<When Separation from Aligned Text Data is Performed by User>

A user can separate text data from aligned text data. First, a user can select text data by continuously pressing the entirety or a part of text data with the pen 2500, drawing a horizontal line through text data, or handwriting a circle to enclose text data.

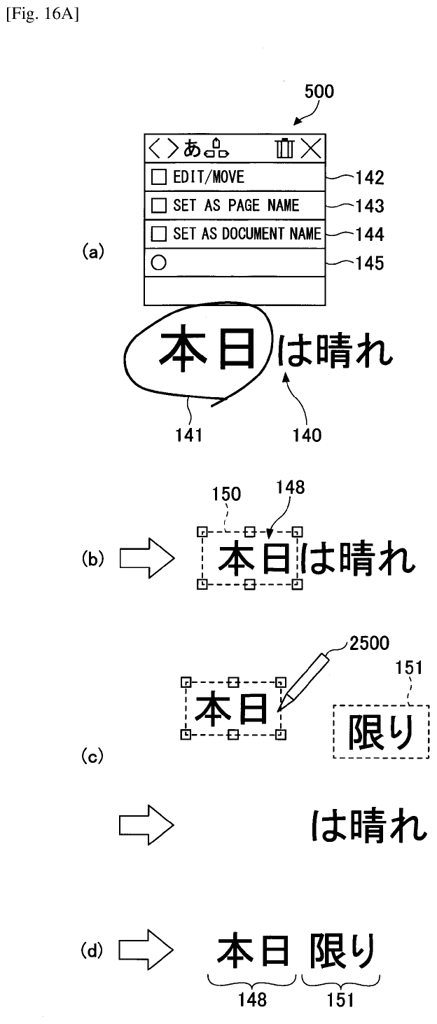

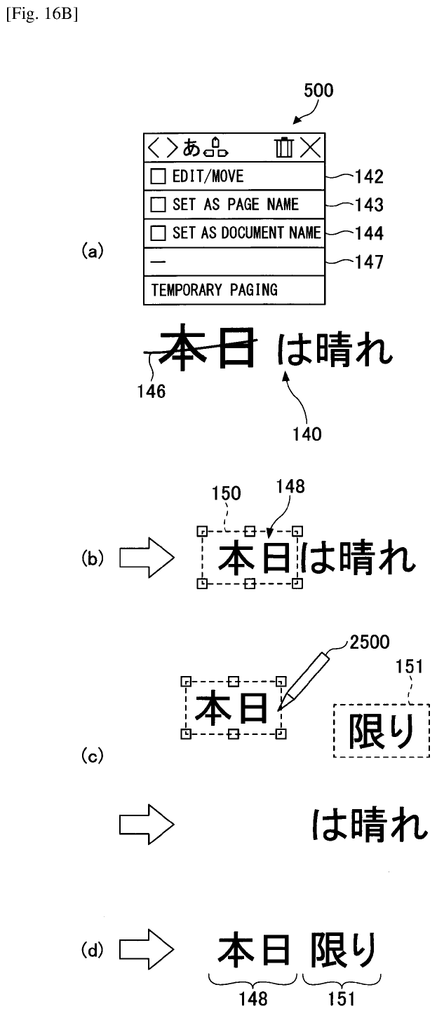

FIGS. 16A and 16B are diagrams illustrating methods of selecting text data. In FIG. 16A, a circle 141 defines a portion of text data 140. The text data 140 (one example of third text data) includes first text data and second text data as a result of alignment.

The selection receiving unit 24 detects text data having a circumscribing rectangle that overlaps with some or all of coordinates of a circumscribing rectangle of handwritten data, from the text data information. When the circumscribing rectangle of the circle 141 and the circumscribing rectangle of the detected text data 140 overlap to a certain extent, the selection receiving unit 24 determines that the thus overlapping section of the text data 140 has been selected.

As a result, the display control unit 26 displays the operation guide 500 suitable for the case where selection from the text data 140 is performed. In FIG. 16A, operation commands “EDIT/MOVE” 142, “SET AS PAGE NAME” 143, and “SET AS DOCUMENT NAME” 144 are displayed. The symbol
“◯”

145 is displayed as the recognition result of the handwritten circle 141 (see FIG. 16A (a)).

Similarly, in FIG. 16B, a horizontal line 146 is handwritten through text data 140.

When respective circumscribing rectangles of the horizontal line 146 and the text data 140 overlap a certain amount or more, the selection receiving unit 24 determines that the thus overlapping section of the text data 140 has been selected. The operation guide 500 is similar to the operation guide 500 of FIG. 16A, except for
“ [symbol] ”

147 displayed as the recognition result of the horizontal line 146 (see FIG. 16B (a)).

When a user presses an operation command “EDIT/MOVE” 142 with the pen 2500, the operation receiving unit 29 receives the command. The display control unit 26 then displays a bounding box 150 to include a selected section character string 148 (meaning “today”) included in the text data 140 (see FIG. 16A (b) and FIG. 16B (b)).

The bounding box 150 is a rectangular border that encloses an image, a shape, or text. A user can move, deform, rotate, increase a size or reduce a size by dragging, etc. the bounding box 150. A user can thus drag the bounding box 150 to move, deform, rotate, increase a size, or reduce a size of the selected character string 148 (see FIG. 16A (c), FIG. 16B (c)).

The moved selected section character string 148 is treated in the same manner as second text data. That is, when a user who has been dragging the bounding box 150 separates the pen 2500 from the display 220 (a pen-up operation), the display position control unit 25 determines whether there is first text data satisfying the predetermined conditions with the selected section character string 148 at that time. When there is the first text data satisfying the predetermined conditions, the display position control unit 25 aligns the selected section character string 148 with the first text data. In FIGS. 16A and 16B, if text data 151 (meaning “only”) satisfies the predetermined conditions, the text data 151 (an example of fourth text data) is regarded as first text data. Thus, the selected section character string 148 is displayed based on the position of the text data 151 (see FIG. 16A (d) and FIG. 16B (d)).

Thus, a user can separate all or part of aligned text data and align the separated text data with other text data.

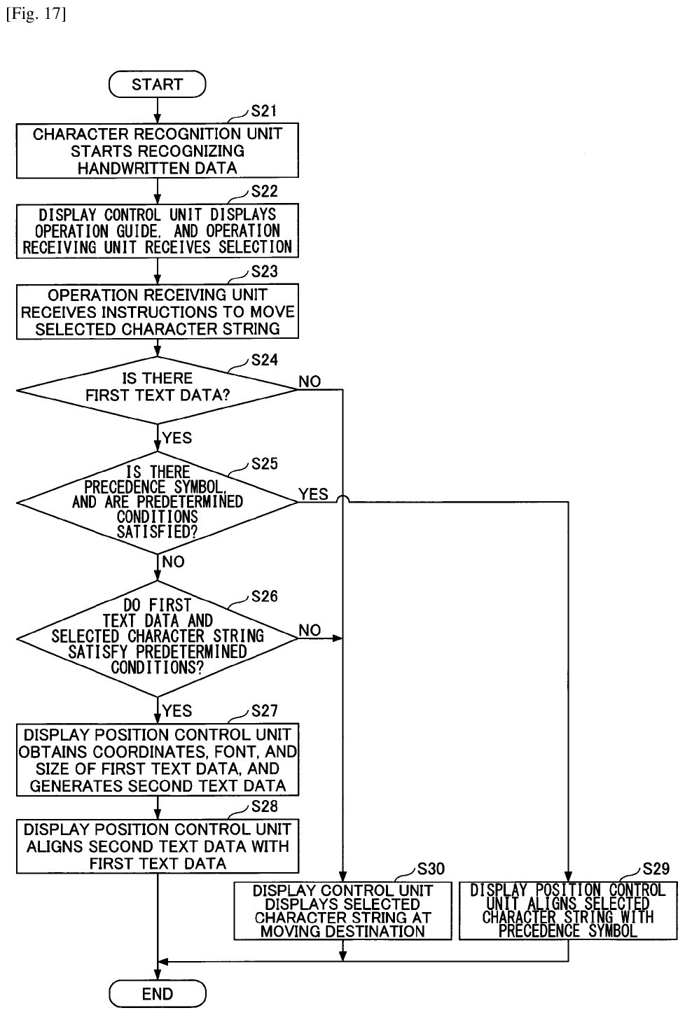

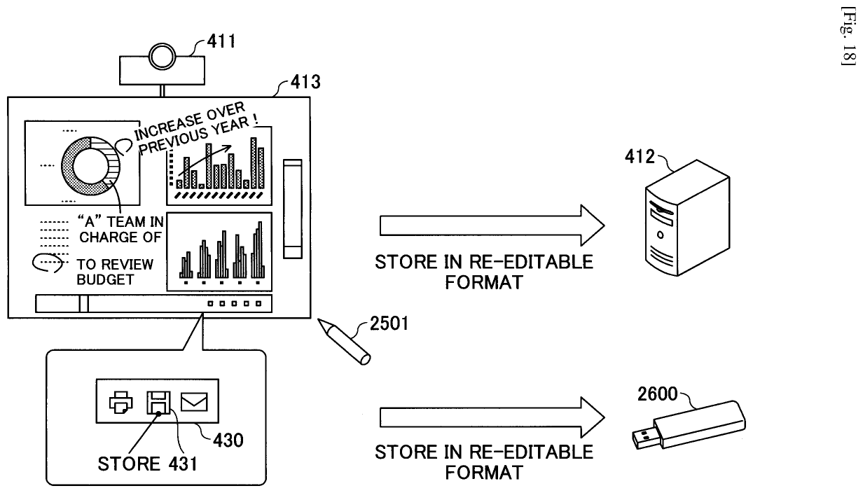

FIG. 17 is an example of a flowchart illustrating a process of aligning a selected section character string 148 separated from text data by the display apparatus 2. The process of FIG. 17 starts in response to a user handwriting one or more strokes. In the description of FIG. 17, the difference from FIG. 14 will be mainly explained.

First, the converting unit 23 starts recognizing handwritten data (step S21). As a result, the converting unit 23 generates a character code of second text data. Further, the selection receiving unit 24 determines whether a part or the entirety of text data already displayed has been selected.

Next, the display control unit 26 displays the operation guide 500, and the operation receiving unit 29 receives a selected operation command candidate 510 or a selected character string candidate 539 (step S22). Because the selection receiving unit 24 determines that a part or the entirety of text data has been selected, the operation guide 500 displays an operation command “EDIT/MOVE” 142.

A user then selects the operation command “EDIT/MOVE” 142 in order to move the selected character string. The operation receiving unit 29 receives the selection of the operation command, and the display control unit 26 displays a bounding box. When the user moves the bounding box, the operation receiving unit 29 receives information of the movement of the selected section character string 148 (step S23). The display control unit 26 displays the bounding box 150 at the thus moved destination. The display position control unit 25 may display also the selected section character string 148 at the same time.

Determination methods of subsequent steps S24 and S25 may be the same as the determination methods of steps S4 and S5 of FIG. 14.

When the determination result of step S24 is No, the display control unit 26 displays the selected section character string 148 at the moved destination (step S30).

When the determination result of step S25 is Yes, the display position control unit 25 aligns the selected section character string 148 with the precedence symbol (step S29).

When the determination result of step S25 is No, the display position control unit 25 determines whether the first text data and the selected section character string 148 satisfy the predetermined conditions (step S26). The display position control unit 25 identifies a set of first text data nearest to the selected section character string. The display position control unit 25 then determines whether the distance between respective circumscribing rectangles of the thus identified set of first text data and the selected section character string 148 is smaller than a threshold (or is smaller than or equal to the threshold) and the respective circumscribing rectangles overlap when viewed in a horizontal direction or a vertical direction.

When the determination result of step S26 is Yes, the display position control unit 25 obtains coordinates, a font, and a size of the first text data from the text data information of Table 1 (d). The display position control unit 25 generates second text data by applying the font and the size obtained to the character code of the selected section character string 148 (step S27). Thus, the font and size of the selected section character string 148 may be changed.

Next, the display position control unit 25 aligns the second text data with the first text data (step S28). The aligning method may be the same as the aligning method of FIG. 14.

Thus, the user can select any character string from two or more sets of text data having been aligned together and move the selected section character string. Then, the display apparatus 2 can align the selected section character string 148 with first text data present at the thus moved destination.

Text data to be moved is not limited to text data aligned in the alignment method described in the present embodiment. A user may move any text data, in whole or in part, and align the moved text data with first text data.

<Major Advantageous Effects>

Thus, the display apparatus 2 of the present embodiment can move all or a part of aligned text data or any text data and align the moved text data with first text data.

### Second Embodiment

With regard to the first embodiment described above, the display apparatus 2 is described as having a large-size touch panel, but the display apparatus is not limited to having such a touch panel. With regard to the present embodiment, a projector-type display apparatus will be described.

### Example 1 of Other Display Apparatus

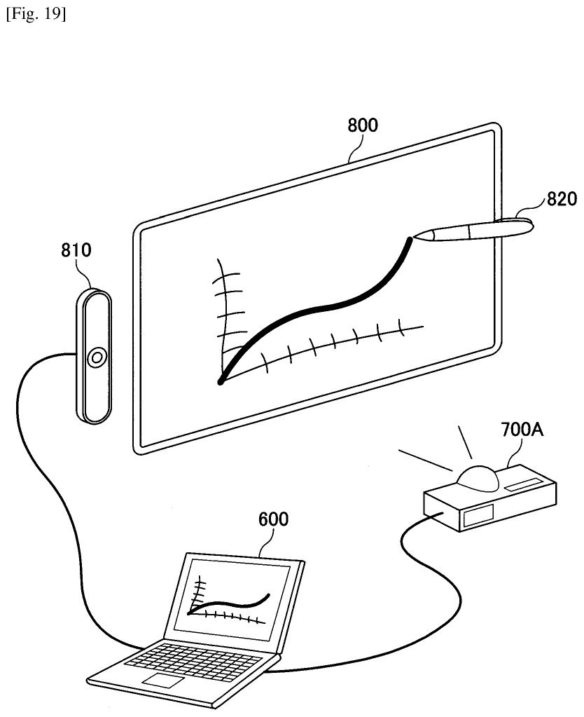

FIG. 18 is a diagram illustrating another configuration example of the display apparatus. In FIG. 18, a projector 411 is located above a common whiteboard 413. The projector 411 corresponds to the display. The typical whiteboard 413 is not a flat panel display integrated with a touch panel, but rather a white board that a user writes directly with a marker. The whiteboard 413 may be replaced with a blackboard, and only a flat plate large enough to project an image can be used instead of the whiteboard 413.

The projector 411 has an optical system with an ultra-short focal point so that an image of less distortion can be projected onto the whiteboard 413 with a focal distance on the order of 10 cm or more. The image may have been transmitted from a wirelessly connected PC 400-1 or a PC 400-1 connected by wire, or may have been stored by the projector 411.

A user handwrites on the whiteboard 413 using a dedicated electronic pen 2700. The electronic pen 2700 has a light emitting portion at its tip, for example, that turns on when the user presses the electronic pen 2700 against the whiteboard 413 for handwriting. The light wavelength is near-infrared or infrared, so it is invisible to the user. The projector 411 includes a camera that captures the light emitting portion and analyzes the captured image to determine the direction of electronic pen 2700. Also, the electronic pen 2700 emits sound waves together with emitted light, and the projector 411 calculates the distance in accordance with the time of arrival of the sound waves. The direction and the distance permit identification of the location of the electronic pen 2700. A stroke is drawn (projected) according to a movement of the position of the electronic pen 2700.

The projector 411 projects a menu 430, so when a user presses a button with the electronic pen 2700, the projector 411 identifies the position of the electronic pen 2700 and the pressed button, through a turn-on signal of the switch. For example, when a store button 431 in the menu 430 is thus pressed, a user-written stroke (a set of coordinates) is stored in the projector 411. The projector 411 stores the handwritten information in a predetermined server 412, a USB memory 2600, or the like. The handwritten information is stored on a per page basis. The coordinates are stored instead of image data, allowing a user to re-edit the information. In the present embodiment, however, the menu 430 is not required to be displayed because corresponding operation commands can be invoked through handwriting.

### Example 2 of Other Display Apparatus

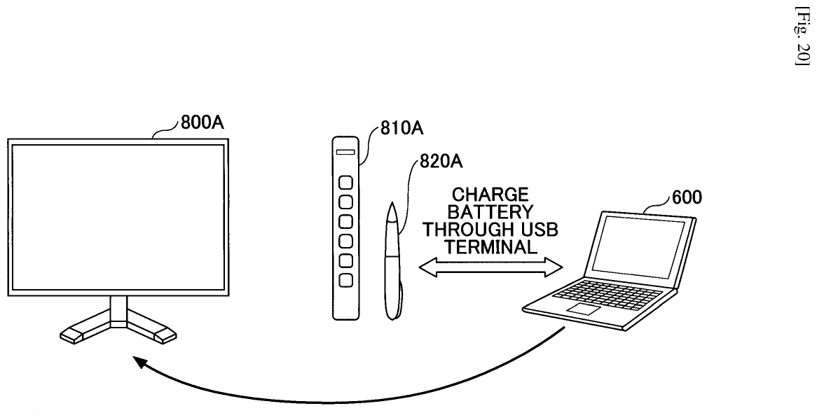

FIG. 19 is a diagram illustrating another configuration example of the display apparatus 2. In the example of FIG. 19, the display apparatus 2 includes a terminal device 600, an image projector 700A, and a pen movement detector 810.

The terminal device 600 is connected to the image projector 700A and the pen movement detector 810 by wire. The image projector 700A projects image data input by the terminal device 600 onto a screen 800.

The pen movement detector 810 is in communication with an electronic pen 820 and detects operation of the electronic pen 820 while the electronic pen 820 is near the screen 800. Specifically, the electronic pen 820 detects and transmits coordinate information indicating a point indicated by the electronic pen 820 on the screen 800 to the terminal device 600.

The terminal device 600 generates image data of a stroke image input through the electronic pen 820 based on coordinate information received from the pen movement detector 810. The terminal device 600 causes the image projector 700A to draw a stroke image onto the screen 800.

The terminal device 600 generates superimposition image data of a superimposition image that is a combination of a background image projected by the image projector 700A and the stroke image input through the electronic pen 820.

### Example 3 of Other Display Apparatus

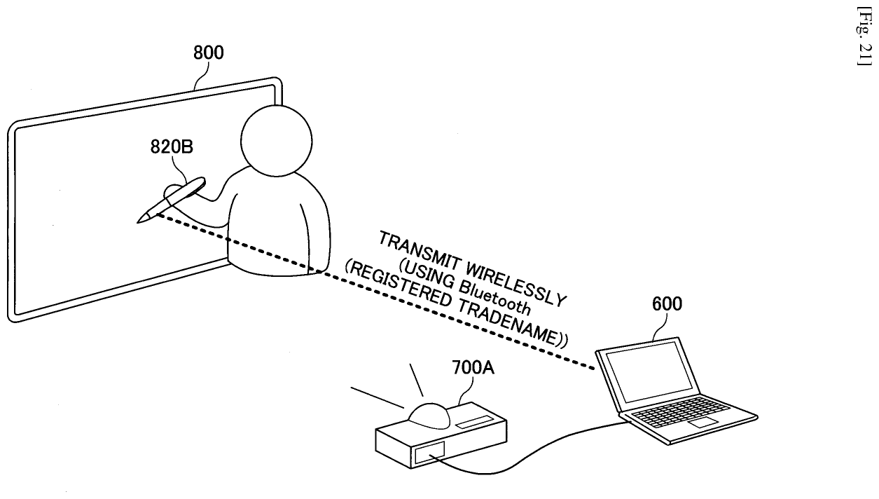

FIG. 20 is a diagram illustrating an example of another configuration of the display apparatus. In the example of FIG. 20, the display apparatus includes a terminal device 600, a display 800A, and a pen movement detector 810.

The pen movement detector 810 is positioned near the display 800A. The pen movement detector 810 detects coordinate information indicating a point indicated by an electronic pen 820A on the display 800A and transmits the coordinate information to the terminal device 600. In the example of FIG. 20, the electronic pen 820A may be charged from the terminal device 600 via a USB connector.

The terminal device 600 generates image data of a stroke image input through the electronic pen 820A based on coordinate information received from the pen movement detector 810. The terminal device 600 displays the image data of the stroke image on the display 800A.

### Example 4 of Other Display Apparatus

FIG. 21 is a diagram illustrating another example of a configuration of the display apparatus. In the example of FIG. 21, the display apparatus includes a terminal device 600 and an image projector 700A.

The terminal device 600 performs wireless communication (such as Bluetooth communication) with an electronic pen 820B and receives coordinate information of a point indicated by the electronic pen 820B on the screen 800. The terminal device 600 generates image data of a stroke image input through the electronic pen 820B based on the received coordinate information. The terminal device 600 causes the image projector 700A to project the stroke image.

The terminal device 600 generates superimposition image data of a superimposition image that is a combination of a background image projected by the image projector 700A and the stroke image input through the electronic pen 820.

Thus, each of the above-described embodiments can be applied in various system configurations.

<Other applications>

Although the display apparatuses, display methods, and programs have been described above with reference to the embodiments, the present invention is not limited to the embodiments, and variations and modifications can be made without departing from the claimed scope.

For example, in the present embodiments, both first text data and second text data are converted from handwritten data, but either the first text data or the second text data may be handwritten data. In this case, because it may be impossible for the display position control unit 25 to use a size and a font of characters, a height of a circumscribing rectangle of second handwritten data is caused to be coincident with a height of a circumscribing rectangle of first handwritten data.

The display apparatus 2 according to the present embodiments aligns second text data with first text data, but may align first text data with second text data. A user may select whether the display apparatus 2 performs alignment based on first text data or second text data.

The display methods according to the present embodiments are suitably applicable to information processing apparatuses having touch panels installed on the apparatuses. An apparatus having the same functions as the functions of the display apparatus may be an electronic blackboard, an electronic whiteboard, an electronic information board, an interactive board, or the like. The information processing apparatus having a touch panel mounted on the apparatus may be, for example, an output device such as a projector (PJ) or a digital signage, an head-up display (HUD), an industrial machine, an imaging device, a sound collector, a medical device, a network home appliance, a personal computer, a cellular phone, a smartphone, a tablet terminal, a game machine, a personal digital assistant (PDA), a digital camera, a wearable PC, a desktop PC, or the like.

According to the present embodiments, a part of the processing performed by the display apparatus 2 may be performed by a server. For example, the display apparatus transmits stroke information to the server, then, obtains, from the server, information to be displayed on the operation guide 500, and displays the information.

In the present embodiments, coordinates of the tip of the pen are detected by the touch panel, but the coordinates of the tip of the pen may be detected through ultrasound. In addition, the pen may emit ultrasonic waves together with emitted light, and the display apparatus 2 calculates the distance in accordance with the time of arrival of the ultrasonic waves. The position of the pen can be determined by the direction and the distance. The projector draws (projects) the pen's moved trajectory as a stroke.

The configuration example such as the configuration depicted in FIG. 6 includes divisions corresponding to main functions in order to facilitate understanding of processing by the display apparatus 2. The present invention is not limited by the specific method of separating the processing into the divisions or by the names of the divisions. The processing of the display apparatus 2 can be divided into more processing units depending on the processing contents. Alternatively, one of the processing units can be further divided to include more processing units.

In the present embodiments, even though a threshold is exemplified as a comparison target, the threshold is not limited to the exemplified value. Therefore, in the present embodiments, for all thresholds, an expression “smaller than” has a meaning equivalent to a meaning of an expression “smaller than or equal to”; and an expression “greater than” has a meaning equivalent to a meaning of an expression “greater than or equal to”. For example, an expression “smaller than a threshold” for a case where the threshold “11” has a meaning equivalent to a meaning of an expression “smaller than or equal to a threshold” for a case where the threshold “10”; and an expression “greater than a threshold” for a case where the threshold “10” has a meaning equivalent to a meaning of an expression “greater than or equal to a threshold” for a case where the threshold “11”.

The functions of the embodiments described above may also be implemented by one or more processing circuits. As used herein, a “processing circuit” may be a processor programmed to perform each function by software, such as a processor implemented in an electronic circuit; or a device such as an application specific integrated circuit (ASIC), a digital signal processor (DSP), a field programmable gate array (FPGA), or a common circuit module, designed to perform each function described above.

The present application is based on and claims priority to Japanese Patent Application No. 2020-166450, filed Sep. 30, 2020, the entire contents of which are hereby incorporated herein by reference.

### REFERENCE SIGNS LIST

2 Display apparatus

### CITATION LIST

### Patent Literature

[PTL 1] Japanese Unexamined Patent Application Publication No. 2016-15099

1. A display apparatus comprising:
a processor; and
a memory that includes instructions, which when executed, cause the processor to:
receive handwritten data that is input;
convert the handwritten data into text data; and,
in response to first text data that is being displayed and the handwritten data that is received satisfying a predetermined condition, control, based on a display position of the first text data, a display position of second text data obtained from converting the handwritten data.

2. The display apparatus according to claim 1,
wherein
the instructions, when executed, further cause the processor to,
upon controlling, based on the display position of the first text data, the display position of the second text data, in response to the first text data and the handwritten data satisfying the predetermined condition,
display the second text data in accordance with a font, a size, or a color of the first text data, or a combination of any two or more selected from the font, the size, and the color of the first text data.

3. The display apparatus according to claim 1,
wherein
the predetermined condition includes a first condition that a distance between mutually nearest points of the first text data and the handwritten data is smaller than or is smaller than or equal to a threshold, or a second condition that the first text data and the handwritten data overlap, when viewed in a horizontal direction or a vertical direction, by a length greater than or equal to or a length greater than a threshold, or a combination of the first condition and the second condition.

4. The display apparatus according to claim 3,
wherein
the instructions, when executed, further cause the processor to,
for a case where the first text data and the second text data are of horizontal writing and the predetermined condition is satisfied while the first text data and the handwritten data overlap when viewed in a horizontal direction,
provide no space next to a right edge of the first text data and continuously display the second text data.

5. The display apparatus according to claim 4,
wherein
the instructions, when executed, further cause the processor to,
for the case where the first text data and the second text data are of horizontal writing and the predetermined condition is satisfied while the first text data and the handwritten data overlap when viewed in a horizontal direction,
display the second text data while an upper right corner of a circumscribing rectangle of the first text data is caused to be at a same position as an upper left corner of a circumscribing rectangle of the second text data and a lower right corner of the circumscribing rectangle of the first text data is caused to be at a same position as a lower left corner of the circumscribing rectangle of the second text data.

6. The display apparatus according to claim 3,
wherein
the instructions, when executed, further cause the processor to,
for a case where the first text data and the second text data are of horizontal writing and the predetermined condition is satisfied while the first text data and the handwritten data overlap when viewed in a vertical direction,
display the second text data positioned under the first text data as a new line with respect to the first text data.

7. The display apparatus according to claim 6,
wherein
the instructions, when executed, further cause the processor to,
for the case where the first text data and the second text data are of horizontal writing and the predetermined condition is satisfied while the first text data and the handwritten data overlap when viewed in a vertical direction,
provide no line spacing under the first text data and display the second text data immediately below the first text data with a left edge of the second text data at a same position with respect to a horizontal direction as a left edge of the first text data.

8. The display apparatus according to claim 3,
wherein
the instructions, when executed, further cause the processor to,
for a case where the first text data and the second text data are of vertical writing and the predetermined condition is satisfied while the first text data and the handwritten data overlap when viewed in a vertical direction,
provide no space next to a bottom edge of the first text data and continuously display the second text data.

9. The display apparatus according to claim 3,
wherein
the instructions, when executed, further cause the processor to,
for a case where the first text data and the second text data are of vertical writing and the predetermined condition is satisfied while the first text data and the handwritten data overlap when viewed in a horizontal direction,
display the second text data on a left side of the first text data as a new line with respect to the first text data.

10. The display apparatus according to claim 1,
wherein
the first text data is a character or a mark to be added at a line head.

11. The display apparatus according to claim 3,
wherein
the instructions, when executed, further cause the processor to,
for a case where (i) the first text data and the second text data are of an on-a-per-word-basis space inserting language, (ii) the first text data and the second text data are of horizontal writing, and (iii) the predetermined condition is satisfied while the first text data and the handwritten data overlap when viewed in a horizontal direction,
determine, depending on whether the second text data is a word, whether to provide a space next to a right edge of the first text data and display the second text data or to provide no space next to the right edge of the first text data and display the second text data.

12. The display apparatus according to claim 1,
wherein
the instructions, when executed, further cause the processor to
receive a selection of a portion of third text data that includes the first text data and the second text data displayed based on the position of the first text data, and,
for a case where a display position of the portion of the third text data for which the selection is received is moved, and fourth text data displayed and the portion of the third text data satisfy the predetermined condition,
control, based on a position of the fourth text data, a display position of the portion of the third text data.

13. A display method performed by an information processing apparatus, the display method comprising:
receiving handwritten data that is input;
converting the handwritten data into text data; and,
in response to first text data that is being displayed and the handwritten data that is received satisfying a predetermined condition, controlling, by a display position control unit, based on a display position of the first text data, a display position of second text data obtained from converting the handwritten data by the converting.

14. A non-transitory recording medium storing a program to be executed by an information processing apparatus, the program causing the information processing apparatus to
receive handwritten data that is input;
convert the handwritten data into text data; and,
in response to first text data that is being displayed and the handwritten data that is received satisfying a predetermined condition, control, based on a display position of the first text data, a display position of second text data obtained from converting the handwritten data.
